(19) United States
(12) Patent Application Publication
(10) Pub. No.: US 2007/0217038 A1
(43) Pub. Date: Sep. 20, 2007

(54) Optical mouse

(76) Inventor: Huo-Lu Tsai Yang, Taichung Hsien (TW)

Correspondence Address: HUO-LU TSAI, 235 Chung-Ho, Box 8-24, Taipei, omitted

(21) Appl. No.: 11/374,567

(22) Filed: Mar. 14, 2006

(51) Int. Cl. G02B 7/02

(52) U.S. Cl. 359/823

(57) ABSTRACT

An optical mouse comprises a ball body, a ball seat, an optical lens set, and a circuit board; a surface of the ball body being coated with various colors which are arranged irregularly and the ball body being rotatably installed on the ball seat. The ball seat has a receiving groove for receiving the ball body; and the receiving groove has an opening for exposing part of the ball body. The optical lens set has a focusing lens. One side of the circuit board facing to the optical lens set has a light source and another side thereof is installed with a recording chip; an optical image capturing head is installed on the recording chip.

### FIELD OF THE INVENTION

The present invention relates to computer mice, and in particular to an optical mouse, wherein the surface of a ball of the optical mouse has various colors which are distributed irregularly so as to reduce the manufacturing cost.

### BACKGROUND OF THE INVENTION

Computer mice and track balls are necessary in the operation of computers. In the operation of the track ball, a coordinate encoding device is needed. Conventionally, the track balls are encoded by optical grids and optical coupling devices. In this kind of devices the shafts of grid wheel are in contact with a sliding ball. When the ball rolls, the shafts are rubbed so that the ball rotates. Then the grid at one end of shift rotates so as to shield the light from the light coupling device. Thereby the operation of coordinating is achieved.

However this kind of grid wheel shafts is a mechanical device and the rotation of the grid wheel is induced by the friction contact of the sliding ball. The sliding ball exposes out of the body of the track ball so as to contact the hand of the user. Thus it is easy to have dust which is accumulated on the shafts. When the dust is accumulated to a predetermined thickness, the surface of the sliding ball cannot have a necessary contact effect. Therefore, for a time period, the track ball must be cleaned. The use is inconvenient.

In U.S. Pat. No. 5,288,993, an optical pointer is disclosed. A sliding ball of the pointer is installed with speckles having predetermined density. Thereby an image sensing device is used to sense the speckles. In the manufacturing the sliding ball, the density of the speckles must be taken care. More time is necessary. Thereby the precision of the track ball must be very high. However the cost is high.

### SUMMARY OF THE INVENTION

The object of the present invention is to provide an optical mouse. The surface of a ball of the optical mouse has various colors which are distributed irregularly so as to reduce the manufacturing cost.

To achieve above object, the present invention provides an optical mouse which comprises a ball body, a ball seat, an optical lens set, and a circuit board; a surface of the ball body being coated with various colors which are arranged irregularly and the ball body being rotatably installed on the ball seat.

The ball body is made by mixing plastics with powders.

The ball body is made by molding injection of non-uniform mixing material.

The ball seat has a receiving groove for receiving the ball body; and the receiving groove has an opening for exposing part of the ball body.

The optical lens set has a focusing lens.

One side of the circuit board facing to the optical lens set has a light source and another side thereof is installed with a recording chip; an optical image capturing head is installed on the recording chip. The light source is a light emitting diode tube.

A central line of the image capturing head is shifted from a central line of the ball body at the same direction so as to be toward the direction of the light source.

The ball seat is installed on the circuit board and the optical lens set is installed between the ball seat and the circuit board.

### BRIEF DESCRIPTION OF THE DRAWINGS

FIG. 1 is an exploded perspective view of the optical mouse of the present invention.

FIG. 2 is another exploded perspective view of the present invention, which is view from an orientation different from the FIG. 1.

FIG. 3 is an assembly view of the optical mouse of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

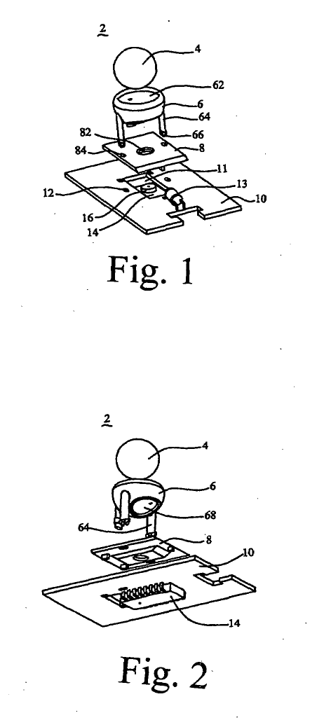

Referring to FIGS. 1 to 3, the present invention is illustrated. The present invention has the following elements. The optical mouse 2 of the present invention includes the following elements.

A ball body 4 has a surface distributed with various colors.

A ball seat 6 is capable of receiving the ball body 4. The ball body 4 is rotatably installed on the ball seat 6. The ball seat 6 has a receiving groove 62 and three pins 64. A distal end of each of two of the three pins 64 has a buckle 66. A bottom of the receiving groove 62 of the ball seat 6 is formed with an opening 68 so that a part of the ball body 4 exposes out. A central portion of the opening 68 is shifted from a lowest point of the ball seat 6;

An optical lens set 8 is installed with a focusing lens 82 and a plurality of installation holes 84. The focusing lens 82 faces toward the opening 68 of the ball seat 6. The pins 64 of the ball seat 6 pass through the installation holes 84.

A circuit board 10 resists against another pin 64 so as to fix the ball seat 6 upon the circuit board 10. The circuit board 10 is formed with a via hole 11 and two fixing holes 12 at two sides of the via hole 11. The installation hole 84 of the ball seat 6 passes through the two fixing holes 12 to connect with the circuit board 10. One side of the circuit board 10 facing the optical lens set 8 has a light source 13 and another side thereof is installed with a recording chip 14. An optical image capturing head 16 is installed on the recording chip 14. The optical image capturing head 16 is installed in the via hole 11 and is positioned corresponding to the focusing lens 82 of the optical lens set 8. In this embodiment, the light source 13 is a light emitting diode tube.

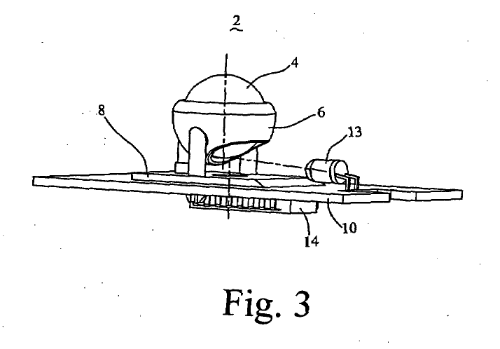

With reference to FIG. 3, a central line of the optical image capturing head 16 is shifted from a central line of the ball body 4 with respect to the direction of the light source 13. Thereby when the light source 13 emits light to the ball body 4, the optical image capturing head 16 will capture the frame at a corresponding to position.

In the present invention, the colors on the surface of the ball body 4 are irregular. The image capturing head captures images about the surface of the ball body 4 continuously so as to record the frames of movement of the ball body 4 with respect to the image capturing head. The images are contrasted with the previous images stored in the recording chip 14 so as to determine the moving direction of the ball body 4. Thereby the vectors about the movement of the ball body 4 with respect to a horizontal axis and a vertical axis are obtained. Then the data is outputted from the recording chip 14 to a computer so as to control the optical mouse.

In the present invention, the optical images are transferred to be recorded in an electronic files. The surfaces of the ball body 4 can be compared immediately so as to identify the moving direction of the ball body 4. With respect to the current art, the ball body 4 of the present invention can be made easily. It can be made by general used plastics mixing with powders, such as powders pearls, aluminum powders, metal powders, or by molding injection of non-uniform mixing material. Thereby the ball body 4 with various irregular colors are obtained. No bad good occurs and cost is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-9. (canceled)

10. An optical mouse comprising:
a ball body having a surface distributed with various colors;
a ball seat capable of receiving the ball body; the ball body being rotatably installed on the ball seat; the ball seat having a receiving groove and three pins; a distal end of two of the three pins having a buckle; a bottom of the receiving groove of the ball seat being formed with an opening so that a part of the ball body exposes out; wherein a central portion of the opening is shifted from a lowest point of the ball seat;
an optical lens set installed with a focusing lens and a plurality of installation holes; the focusing lens facing toward the opening of the ball seat; the pins of the ball seat passing through the installation holes; and
a circuit board resisting against another pin so as to fix the ball seat upon the circuit board; the circuit board being formed with a via hole and two fixing holes at two sides of the via hole; the installation hole of the ball seat passing through the two fixing holes to connect with the circuit board; one side of the circuit board facing the optical lens set having a light source and another side thereof being installed with a recording chip; an optical image capturing head being installed on the recording chip; the optical image capturing head being installed in the via hole and being positioned corresponding to the focusing lens of the optical lens set; and
wherein a central line of the ball body passing through an axial center of the ball body is not matched to a center line of the focusing lens; and light emitted from the light source is incident to the ball body at an incident point shifted from the central line of the ball body passing through the axial center of the ball body so that when the light source emitting light to the ball body, the optical image capturing head will capture the frame at a corresponding position; and
wherein the focusing lens is installed upon the image capturing head and light emitted from the light source is directly transferred to the ball body without being interfered by the focusing lens set; and
wherein the colors on the surface of the ball body are irregular; the image capturing head captures images about the surface of the ball body continuously so as to record the frames of movement of the ball body with respect to the image capturing head; the images are contrasted with the previous imaged storage in the recording chip so as to determine the moving direction of the ball body; thereby the vectors about the movement of the ball body with respect to a horizontal axis and a vertical axis; then the data is outputted from the recording chip to a computer so as to control the optical mouse.

11. The optical mouse as claimed in claim 10, wherein the ball body is made by mixing plastics with powders.

12. The optical mouse as claimed in claim 10, wherein the ball body is made by molding injection of non-uniform mixing material.

13. The optical mouse as claimed in claim 10, wherein the light source is a light emitting diode tube.
